(19) United States
(12) Patent Application Publication
(10) Pub. No.: US 2020/0219027 A1
(43) Pub. Date: Jul. 9, 2020

(54) KNOWLEDGE TRANSFER-BASED MODELING METHOD FOR BLAST FURNACE GAS SCHEDULING SYSTEMS

(71) Applicant: DALIAN UNIVERSITY OF TECHNOLOGY, Dalian, Liaoning (CN)

(72) Inventors: Zheng LV, Dalian, Liaoning (CN); Jun ZHAO, Dalian, Liaoning (CN); Ying LIU, Dalian, Liaoning (CN); Wei WANG, Dalian, Liaoning (CN)

(21) Appl. No.: 16/624,780

(22) PCT Filed: Jun. 15, 2018
(86) PCT No.: PCT/CN2018/091369

§ 371 Date: Dec. 19, 2019

(51) Int. Cl. G06Q 10/06; G06N 5/02; H02J 3/00; G06K 9/62; G06F 16/28; G06F 17/16

(52) U.S. Cl. CPC G06Q 10/06312; G06N 5/025; G06N 5/022; H02J 3/004; G06Q 50/06; G06K 9/6212; G06F 16/288; G06F 17/16; H02J 3/003

(57) ABSTRACT

A knowledge transfer-based modeling method for blast furnace gas scheduling systems, firstly, building energy body models of all stages of energy generation, transmission, consumption, storage and conversion based on pipe network structures of gas systems, and extracting common structure features of different gas systems based on the energy models; secondly, designing a data distribution feature-based membership function transfer method, learning mapping relations between data of the different gas systems according to distribution features of the data, and then transferring membership functions; thirdly, proposing a feature-based fuzzy rule transfer method, mapping rule structures of different systems to adjacent low-dimensional features, and realizing rule transfer in a rule reconstruction mode; and finally, designing a scheduling data-based knowledge transfer adjustment strategy, inputting actual scheduling data of blast furnace gas systems into the models, and adjusting corresponding rule parameters by taking a minimum deviation of an output scheduling scheme as a goal.

### TECHNICAL FIELD

The present invention belongs to the field of information technology, relates to semantic feature extraction, feature reconstruction, data mining, fuzzy reasoning and transfer learning, and particularly relates to a knowledge transfer learning-based modeling method for blast furnace gas scheduling systems of metallurgical enterprises. The present invention designs a transfer learning method for gas scheduling knowledge by using the structural similarity of energy systems based on scheduling knowledge information existing in other gas systems and operating data saved in blast furnace gas systems. By conducting feature extraction and transfer learning on gas data, the model mines feature information in different gas system structures and scheduling knowledge, then transfers a scheduling rule, and corrects the rule through the actual scheduling data of the blast furnace gas systems. By means of this method, scheduling knowledge summarized in practical work can be more effectively utilized, and can be widely popularized in the scheduling of other energy media of metallurgical enterprises.

### BACKGROUND

Metallurgical enterprises belong to the industry high in energy consumption, high in pollution and high in emission. How to achieve energy saving and consumption reduction has always been one of the most serious problems faced with the metallurgical industry. With the shortage of primary energy and the improvement of new energy-saving technologies, whether the byproduct gas generated in the metallurgical production process can be reasonably utilized will directly affect the energy consumption cost and energy saving and emission reduction effect of the whole metallurgical industry (J. Yang, J. Cai, W. Sun, J. Liu. (2015). Optimization and scheduling of byproduct gas system in steel plant. Journal of Iron and Steel Research (English edition) 22(5), 408-413.). Blast furnace gas is a byproduct generated in the iron smelting process, the production process thereof is continuous and the amount of gas generated is large, in addition, there is a furnace change operation in the hot blast stove unit in the iron smelting stage, so that the generation amount of blast furnace gas is greatly fluctuated, and the problem of imbalance between production and consumption of gas is caused. At the production site, a certain amount of gas imbalance can be buffered by gas holders. However, the capacity of gas holders is limited, if the production process is unreasonably scheduled, there is a need to ignite excess gas for dissipation, resulting in waste of energy. Otherwise, if the amount of gas is seriously insufficient, it may cause production stoppage in some production stages, affecting the normal production plan. Therefore, reasonable scheduling of blast furnace gas can ensure the reasonable use of gas, improve the use efficiency of secondary energy, and reduce the inefficient discharge of gas.

At present, in the actual production, the comprehensive balance of blast furnace gas of metallurgical enterprises is mainly based on real-time flow monitoring and level alarm mechanisms, and scheduling decisions are made through the experience of schedulers. So far, there is no perfect theoretical method to model the scheduling problems of blast furnace gas. Due to the large number of users using gas systems, complicated pipe networks, and different experience of all schedulers, gas escape and shortage occur from time to time. For the research of scheduling methods, some scholars use mathematical programming methods to conduct modeling and analysis, to obtain the optimum scheduling scheme by solving the mathematical model (L. Zhou, Z. W. Liao, J. D. Wang, B. B. Jiang, Y. R. Yang, W. L. Du. (2015). Energy configuration and operation optimization of refinery fuel gas networks. Applied Energy, 139:365-375.). The built scheduling model consists of two parts: objective function and constraint condition, wherein the objective function is usually used to minimize the operating cost and maximize the production yield, and the constraint condition is established according to the production process constraints and physical constraints. Some scholars use complicated network, Bayesian network and other network methods to dynamically describe the objects to be scheduled, and build a scheduling model to convert the scheduling problems in the production process into node traversal processes on the network (J. Zhao, W. Wang, K. Sun, Y. Liu. (2014). A bayesian networks structure learning and reasoning-based byproduct gas scheduling in steel industry. IEEE Transactions on Automation Science and Engineering, 11(4): 1149-1154.). In addition, for the uncertain information about the actual production process, some scholars use the fuzzy-based scheduling method to convert scheduling models into fuzzy rules, and then map the real-time information about the system to the corresponding modes in a scheduling instruction set through a fuzzy controller, thus generating scheduling instructions (Chen, X., & Azim, A. (2017). TFS: towards fuzzy rule-based feedback scheduling in networked control systems. Intelligent Industrial Systems (4), 1-13.). In recent years, a large number of scholars have used data mining, heterogeneous data processing and other related technologies to analyze and process a large number of off-line and on-line data generated in the manufacturing process, to mine the experience, knowledge and rules implied in the data, and then further apply same to optimization and management of the production process to solve the scheduling problem in the complicated manufacturing process that is difficult to solve by the traditional scheduling method (Long, H., Zhang, Z., Sun, M. X., & Li, Y. F. (2018). The data-driven schedule of wind farm power generations and required reserves. Energy.).

However, these methods have obvious disadvantages: firstly, because the complicated manufacturing process involves multiple varieties of material energy, energy-consuming equipment and energy conversion equipment, and the environment at the production site is bad, it is difficult for the mechanism model to reflect the complexity and randomness of the actual environment. Secondly, when the mathematical programming method is used to build scheduling models, many variables and constraint conditions are generated, a large amount of data are required, long time is consumed during calculation, with the expansion of the scheduling scale, the difficulty of solving the scheduling problem is increased sharply. Thirdly, although the network-based scheduling method has the advantages of simple structure and a small number of calculations, and can describe the dynamic characteristics in a complicated production process relatively well, the method has the disadvantage that it is difficult to determine parameters of the network models built by means of the method. In addition, the use of scheduling rules to determine the scheduling scheme avoids a large number of complicated calculations, has high efficiency and high model stability, for complicated industrial scheduling problems, it is difficult to build a rule base through experiential knowledge. Finally, the data-based scheduling method requires a large amount of tagged data as samples, however, it is impossible to acquire enough sample data in practical application sometimes.

### SUMMARY

The technical problem to be solved by the present invention is the balanced scheduling problem of the existing blast furnace gas systems of metallurgical enterprises. To solve the above problem, a feature and data-based transfer learning method is designed to transfer the scheduling knowledge information about other gas systems to the scheduling problems of blast furnace gas systems, comprising the following steps: firstly, building energy ontology models of all stages of energy generation, transmission, consumption, storage and conversion based on pipe network structures of gas systems, and extracting common structure features of different gas systems based on the energy models; secondly, designing a data distribution feature-based membership function transfer method, learning mapping relations between data of the different gas systems according to distribution features of the data, and then transferring membership functions; thirdly, proposing a feature-based fuzzy rule transfer method, mapping rule structures of the different systems to adjacent low-dimensional features, and realizing rule transfer in a rule reconstruction mode; and finally, designing a scheduling data-based knowledge transfer adjustment strategy, inputting actual scheduling data of blast furnace gas systems into the models, and adjusting corresponding rule parameters by taking a minimum deviation of an output scheduling scheme as a goal. By means of the present invention, the existing scheduling knowledge in the gas systems can be fully utilized, and the existing knowledge can be transferred to other energy systems, thereby greatly reducing the workload of converting experiential knowledge into scheduling models, and improving the modeling efficiency of scheduling models.

The technical solution of the present invention is:

A knowledge transfer-based modeling method for blast furnace gas scheduling systems, comprising the following four parts:

(1) determining model structures, building ontology models of gas systems, and extracting common structure features of different gas systems;

(2) according to the determined model structures, readjusting memberships of all input and output variables of gas system scheduling models, collecting corresponding historical data from a field database, learning mapping relations between data of corresponding structures of the different gas systems according to distribution features of the data, and then transferring membership functions of the variables;

(3) according to the determined model structures, reconstructing existing fuzzy rules of the gas systems, and then realizing rule transfer; and

(4) slightly adjusting and optimizing the transferred scheduling knowledge through actual scheduling data.

The present invention has the following effects and benefits:

By means of the present invention, by making full use of the existing relevant knowledge, a large amount of scheduling knowledge of different gas systems are transferred to blast furnace gas systems, and knowledge information is dynamically adjusted and optimized through actual data, so the utilization rate of knowledge is effectively increased, and a new solution is provided to build scheduling models. By means of this experiential knowledge and data-based method, rich expert experience of different systems can be merged with actual data information, increasing the modeling efficiency of scheduling models.

By means of this method, by making full use of knowledge information and data features of gas systems, the modeling efficiency of scheduling models of blast furnace gas systems is greatly improved, on-line decision support is provided for balanced scheduling and efficient production of blast furnace gas systems, and a new strategy for effectively using scheduling knowledge is provided.

### DESCRIPTION OF DRAWINGS

FIG. 1 (a) is a diagram showing a pipe network structure of a blast furnace gas system.

FIG. 1 (b) is a diagram showing a pipe network structure of a Linz-donawitz gas system.

FIG. 2 shows a ontology model of a blast furnace and a Linz-donawitz gas system.

FIG. 3 is a flow chart showing a scheduling knowledge transfer learning.

FIG. 4 (a) shows adjustment of a power plant in a blast furnace gas scheduling scheme.

FIG. 4 (b) shows adjustment of a desorption tower in a blast furnace gas scheduling scheme.

FIG. 5 shows gas holder variation trends in different scheduling schemes.

### DETAILED DESCRIPTION

To better understand the technical solution of the present invention, the embodiments of the present invention will further be described by taking the blast furnace gas system of Domestic Baosteel Group Corporation with high automation level as an example. The Corporation's blast furnace gas generation source includes four blast furnaces, which generate about 200km³ of blast furnace gas per hour. Some of the gas is directly used by the hot blast stove, and the rest of the gas is used by various production units, boilers, power plants, and other adjustment users through a transmission and distribution system consisting of a pipe network, a dust removal device and a pressuring station; the production units mainly include coke oven, hot rolling, cold rolling, chemical product and other production units; two gas holders are arranged in the system to buffer the influence of imbalance between production and consumption of a certain amount of gas on the system; if there is excess blast furnace gas, there is a need to ignite excess blast furnace gas for dissipation by the desorption tower.

By means of the present invention, scheduling knowledge of other gas systems are transferred to blast furnace gas systems, taking the Linz-donawitz gas system as an example, the Linz-donawitz gas system includes six converters as Linz-donawitz gas generation units which generates Linz-donawitz gas of about 200 km³ per hour; has about 30 main consumption users mainly including blast furnace, hot rolling and cold rolling, lime kiln and the like; and also has a generator unit, three 70-ton low-pressure boilers, and one heat and power unit as gas adjustment users; the pipe network is equipped with four 80,000 m³ gas holders.

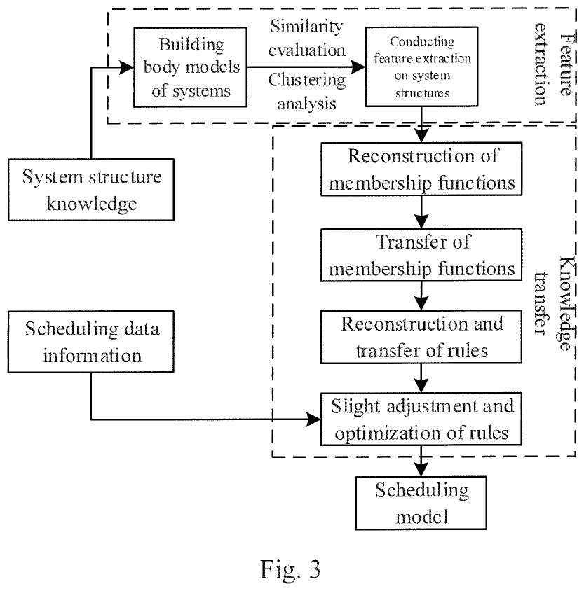

The present invention proposes a knowledge transfer-based modeling method for blast furnace gas scheduling systems, taking the Linz-donawitz gas system as an example, according to the knowledge transfer learning flow shown in FIG. 3, comprising the following specific implementation steps:

Step 1: according to actual pipe network structures of gas scheduling systems, building corresponding ontology models thereof, wherein in the ontology models, let the nodes thereof represent different equipment entities respectively and the connecting lines between nodes represent energy supply and demand balance relations between different entities, including energy generation, use, storage and conversion;

Step 2: conducting feature extraction on the ontology models built in step 1, to find identical structure features of the blast furnace gas system and the Linz-donawitz gas system, and determining input and output variables of scheduling models according to the identical structures;

Step 2.1. to determine the similarity between entities of the blast furnace gas system and the Linz-donawitz gas system, building a similarity matrix S first, where each element s(eqₐ,eq_{b}) represents the similarity between nodes of the blast furnace gas system eqₐ and nodes of the Linz-donawitz gas system eq_{b}, as shown in formula (1):

$$s ( {eq}_{a} , {e}_{b} ) = \{ \begin{matrix}1 & {eq}_{a} = {eq}_{b} \\ \begin{matrix}\frac{η}{\vert I ( {eq}_{a} ) \vert \vert I ( {eq}_{b} ) \vert} \\ {\sum }_{{eq}_{j} ∈ I ( {eq}_{b} )} {\sum }_{{eq}_{i} ∈ I ( {eq}_{a} )} s ( {eq}_{i} , {eq}_{j} )\end{matrix} & \begin{matrix}{eq}_{a} \neq {eq}_{b} an {eq}_{a} , {eq}_{{b}^{′}} \\ have identical attribute\end{matrix} \\ 0 & \begin{matrix}{eq}_{a} \neq {eq}_{{b}^{\cdot }} an {eq}_{a} , {eq}_{{b}^{′}} \\ have different attributes\end{matrix}\end{matrix} \qquad ( 1 )$$

where |(eqₐ)| and |I(eq_{b})| respectively represent the number of nodes indicating the nodes of the gas system eqₐ and the nodes of the gas system eq_{b} in the ontology models, and η∈[0.6,0.8] represents a damping coefficient;

Step 2.2. according to the relation between production and consumption of energy media, putting all the generation entities of the Linz-donawitz gas system and the blast furnace gas system into sets R_{LDGin} and R_{BFGin}, and determining the corresponding relation between the entities in the two sets;

Step 2.2.1. determining identical entities in the two sets first, each identical entity forming a set of corresponding relation;

Step 2.2.2. for different entities in the sets, according to the size of the similarity s , merging same with the most similar identical entities in respective sets; if there is no identical entity, merging all the entities in R_{LDGin} and R_{BFGin} respectively, and forming a set of corresponding relation;

Step 2.3. conducting the same processing on consumption entities as on the generation entities, obtaining corresponding relations between all the entities of the Linz-donawitz gas system and the blast furnace gas system finally, determining identical structure features thereof, and taking identical structures as input/output variables of the models;

Step 3. extracting energy related data of the blast furnace gas system and the Linz-donawitz gas system from a database, based on the input and output variables of the models determined in step 2, reconstructing membership functions of the original scheduling model of the Linz-donawitz gas system, and transforming nodes to be merged;

Step 3.1. using a triangular membership function, wherein the i^{th} membership function of the node is as follows:

$${l}_{i} ( x , {a}_{i} , {b}_{i} , {c}_{i} ) = \{ \begin{matrix}0 & x \leq {a}_{i} \\ \frac{x - {a}_{i}}{{b}_{i} - {a}_{i}} & {a}_{i} \leq x \leq {b}_{i} \\ \frac{{c}_{i} - x}{{c}_{i} - {b}_{i}} & {b}_{i} \leq x \leq {c}_{i} \\ 0 & x \geq {c}_{i}\end{matrix} \qquad ( 2 )$$

where aᵢ, and cᵢ determine “foot”, and bᵢ determines “peak”;

Step 3.2. for two interdependent nodes, representing same with p and q respectively, so that membership functions are lₚᵢ(x, aᵢ, bᵢ, cᵢ) and l_{qi}(x, aⱼ, bⱼ, cⱼ) respectively, where i∈{1,2, . . . , m}, j∈{1,2, . . . , n}, m and n respectively represent the number of membership functions of two nodes, and m≥n ; and reconstructing the membership functions of the two nodes by means of formulae (3-5):

$$\begin{matrix}if j = 1 & \\ \{ \begin{matrix}{b}_{pqj} = {b}_{pj} + {b}_{q 1} \\ {c}_{pqj} = {c}_{pj} + {b}_{q 1}\end{matrix} \\ if j = m & ( 3 ) \\ \{ \begin{matrix}{b}_{pqj} = {b}_{pj} + {b}_{qn} \\ {c}_{pqj} = {c}_{pj} + {b}_{qn}\end{matrix} \\ if 1 < j < m & ( 4 ) \\ \{ \begin{matrix}{b}_{pqj} = {b}_{pj} + \frac{{b}_{qn} - {b}_{q 1}}{2} + {b}_{q 1} \\ {c}_{pqj} = {c}_{pj} + \frac{{b}_{qn} - {b}_{q 1}}{2} + {b}_{q 1}\end{matrix} & ( 5 )\end{matrix}$$

step 3.3. for nodes having relevance, conducting data collection and merge on same, and directly determining parameters of membership functions thereof according to artificial experience and data distribution;

Step 4: learning the mapping relation between the blast furnace gas system and the Linz-donawitz gas system according to data distribution features, and transferring membership functions of the Linz-donawitz gas system to the model of the blast furnace gas system; and mapping the data distribution of the Linz-donawitz gas system to the blast furnace gas system by means of the histogram specification method, to make the two systems have similar distribution features, including the following specific steps:

Step 4.1. for the μ^{th} variable, respectively reading data X_{L}^{μ} of the Linz-donawitz gas system and data X_{B}^{μ} of the blast furnace gas system from the database, and combining same into a new data set D(X_{L}^{μ}, X_{B}^{μ}); discretizing D into p intervals, counting frequency ν under each interval for the data of the Linz-donawitz gas system and the blast furnace gas system respectively, forming frequency vectors V_{L}=[ν_{L1}, ν_{L2}, . . . , ν_{Lp}] and V_{B}=[ν_{B1}, ν_{B2}, . . . , ν_{Bp}], where νₗₚ represents frequency of the data of the Linz-donawitz gas system under the p^{th} interval, ν_{Bp} represents frequency of the data of the blast furnace gas system under the p^{th} interval, i.e. the number of data;

Step 4.2. according to the frequency vectors V_{L} and V_{B}, calculating cumulative frequency vectors S_{L}=[s_{L1}, s_{L2}, . . . , s_{Lp}] and S_{B}=[s_{B1}, s_{B2}, . . . , s_{Bp}],

$$\begin{matrix}{s}_{Lp} = {\sum }_{k = 1}^{p} {v}_{Lk} & ( 6 ) \\ {s}_{Bp} = {\sum }_{k = 1}^{p} {v}_{Bk} & ( 7 )\end{matrix}$$

Step 4.3. determining a mapping relation between data intervals of the blast furnace gas system and the Linz-donawitz gas system; first, fixing an interval γ of the data of the blast furnace gas system, and then calculating difference between same and the cumulative frequency of the data of the Linz-donawitz gas system in sequence;

d_{α,β}=|s_{Bα}−s_{Lβ}|, β=1,2, . . . ,p (8)

if the difference d_{α,β} is the minimum, obtaining a new termination serial number λ_{α}=β of the data interval of the Linz-donawitz gas system, so that the data interval α of the blast furnace gas system may correspond to the data interval (λ_{α-1}, λ_{α}] of the Linz-donawitz gas system, where λ₀=0;

Step 4.4. acquiring left border RLₘₗ and right border RLₘᵣ of the data interval (λ_{α-1}, λ_{α}] of the Linz-donawitz gas system and left border RBₘₗ and right border RBₘᵣ of the data interval i of the blast furnace gas system, so that the formula of linear mapping from the data interval of the Linz-donawitz gas system to the data interval of the blast furnace gas system is as follows:

$${f}_{α} ( x ) = \frac{{RB}_{mr} - {RB}_{ml}}{{RL}_{mr} - {RL}_{ml}} x + {RB}_{ml} - \frac{{RB}_{mr} - {RB}_{ml}}{{RL}_{mr} - {RL}_{ml}} {RL}_{ml} \qquad ( 9 )$$

Step 4.5. according to the mapping relation f_{α}(x), transferring a membership function of the Linz-donawitz gas system to the blast furnace gas system, and obtaining a new membership function:

$$\begin{matrix}{l}^{′} ( x , {a}^{′} , {b}^{′} , {c}^{′} ) = \{ \begin{matrix}0 & x \leq {a}^{′} \\ \frac{x - {a}^{′}}{{b}^{′} - {a}^{′}} & {a}^{′} \leq x \leq {b}^{′} \\ \frac{{c}^{′} - x}{{c}^{′} - {b}^{′}} & {b}^{′} \leq x \leq {c}^{′} \\ 0 & x \geq {c}^{′}\end{matrix} & ( 10 ) \\ {a}^{′} = fa ( a ) , {b}^{′} = fb ( b ) , {c}^{′} = fc ( c ) & ( 11 )\end{matrix}$$

where fa( ), fb( ), fc( ) represent the mapping relations corresponding to data intervals in which the data a, b, c of the Linz-donawitz gas system are located;

step 5: based on the input and output variables of the models determined in step 2, reconstructing the rule of the original scheduling model of the Linz-donawitz gas system, and merging the input variables to be merged in the rule antecedent; if the rule to be reconstructed is as shown in formula (12), the variables to be merged are x₁ and x₂, and the reconstructed rule is as shown in formula (13), reconstructing the membership function of the merged variable x′ by means of formulae (3-5), and determining l_{pqk} by means of formula (14);

$$\begin{matrix}if {x}_{1} is {l}_{pi} and {x}_{2} is {l}_{qj} and … , then … & ( 12 ) \\ if {x}^{′} is {l}_{pqnew} and … , then … & ( 13 ) \\ {l}_{pqnew} = \{ {l}_{pqk} \vert {max}_{k} {l}_{pqk} ( {b}_{{x}_{1} , {l}_{pi}} + {b}_{{x}_{2} , {l}_{qj}} ) \} & ( 14 )\end{matrix}$$

after rule reconstruction, if the new scheduling model of the Linz-donawitz gas system has the same structure and data distribution features as the blast furnace gas system, directly transferring the scheduling knowledge to obtain the scheduling model of the blast furnace gas system;

step 6: inputting actual scheduling data of the blast furnace gas system into the scheduling model, and slightly adjusting and optimizing the transferred scheduling knowledge according to the scheduling scheme and deviation rate; since the knowledge obtained by transfer of the Linz-donawitz gas system is incomplete and inaccurate for the blast furnace gas system, further improving the robustness and accuracy of the model using the error threshold;

step 6.1. for the output scheme y, if the deviation between a certain output variable and the actual scheme is greater than the threshold h, indicating that the knowledge obtained by transfer is incomplete and cannot cover all cases of the sample, adding a new scheme for the scheduling model;

step 6.2. if the deviation between each output variable of the output scheme y and the actual scheme is less than the threshold h, optimizing various output membership function parameters by means of particle swarm optimization, where aₒⱼ, bₒⱼ, cₒⱼ represent parameters of all membership functions of the output variable yⱼ, aₒⱼⁱ, bₒⱼⁱ, cₒⱼⁱ represent parameters of the i^{th} membership function, the actual adjustment scheme of the blast furnace gas system is y′ᵢ, the model output adjustment scheme is yᵢ, if it is defuzzified by means of the centroid method centroid, the optimization goal of particle swarm optimization is to minimize the model output error, as shown in formula (19), and corresponding constraint conditions are as shown in formula (20):

$$\begin{matrix}{min}_{{a}_{oj} , {b}_{oj} , {c}_{oj}} L ( {a}_{oj} , {b}_{oj} , {c}_{oj} ) = \vert {y}_{j} - {y}_{j}^{′} \vert & ( 19 ) \\ s . t . \{ \begin{matrix}{a}_{o}^{i} < {b}_{o}^{i} < {c}_{o}^{i} \\ {a}_{o}^{i - 1} < {a}_{o}^{i} < {c}_{o}^{i - 1} \\ {c}_{o}^{i - 1} \\ 0 \leq {a}_{o}^{i}\end{matrix} . & ( 20 )\end{matrix}$$

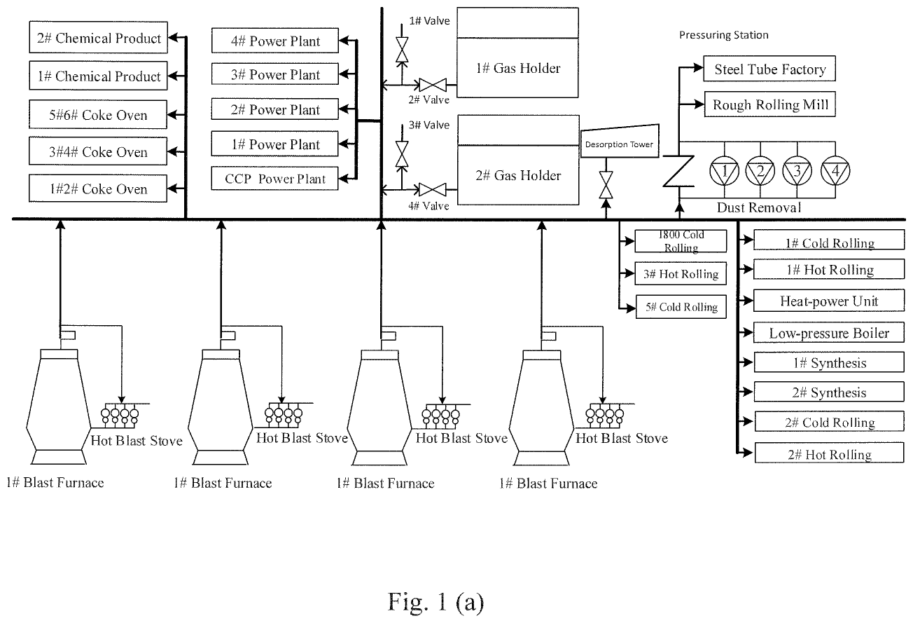

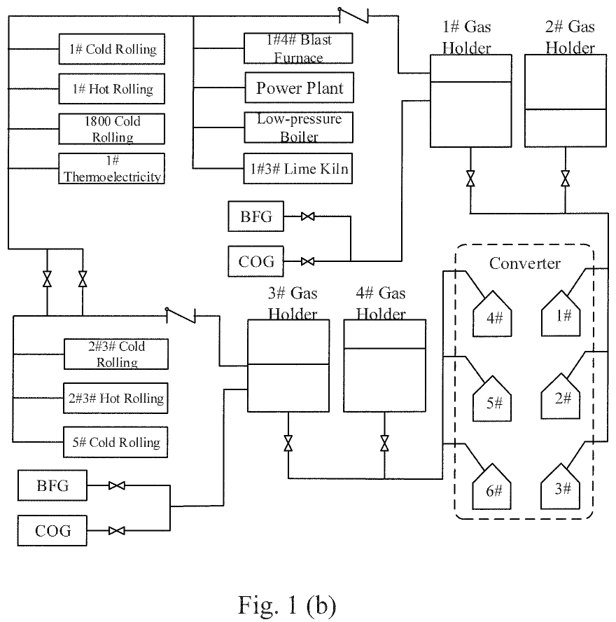

As shown in FIG. 1 (a) and FIG. 1 (b), both the blast furnace gas system and the Linz-donawitz gas system are composed of gas generation sources, consumption users, power plant boilers, gas holders, gas transport pipe networks and other units, wherein the two pipe networks have very similar structure features. In the present invention, the structures of the gas systems are deeply analyzed, and transfer learning is conducted on the scheduling knowledge based on the similarity between the structures.

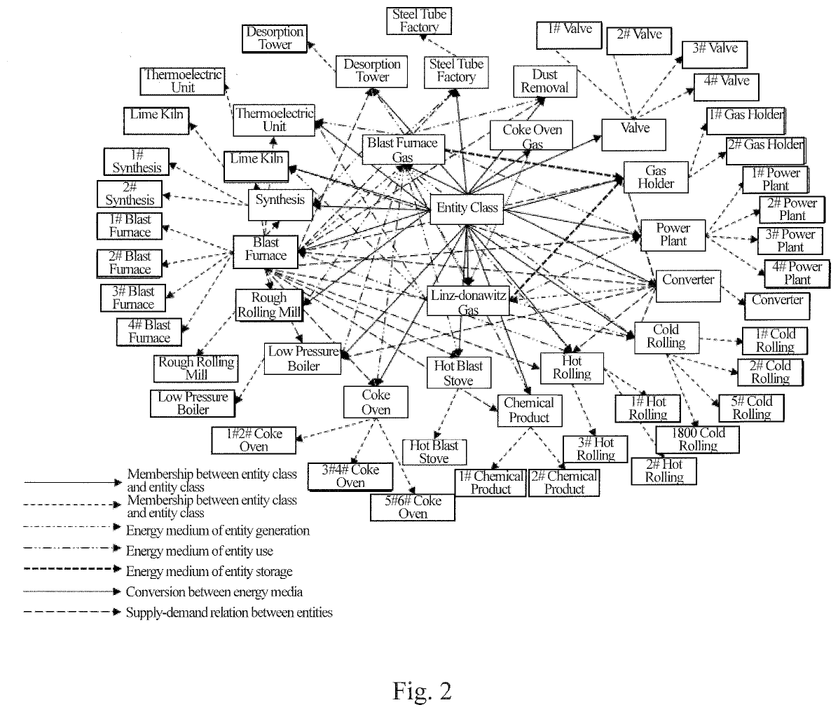

FIG. 2 gives a built ontology model of a system in this article. In the present invention, common structure features of different energy systems are searched through the ontology models, and then input and output variables of the scheduling models are determined.

FIG. 3 shows a core technological stage of the present invention. The scheduling modeling method comprises: firstly, conducting analysis on system structure knowledge, building ontology models thereof, obtaining common structure features of different gas systems by means of similarity evaluation and clustering analysis methods, and determining input and output variables of scheduling models thereof; on this basis, by reconfiguration of membership functions, transfer of membership functions, reconfiguration and transfer of rules, based on the rule of scheduling data, slightly adjusting and optimizing scheduling knowledge to complete scheduling knowledge transfer, and obtaining a new scheduling model finally. The modeling method can be applied to other energy systems.

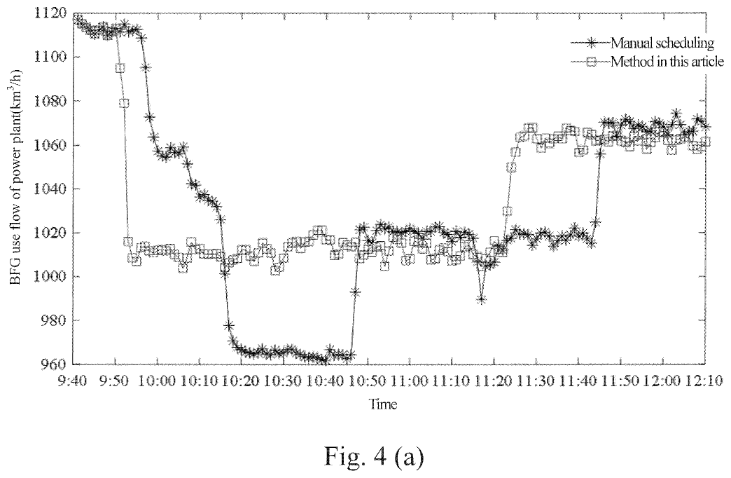

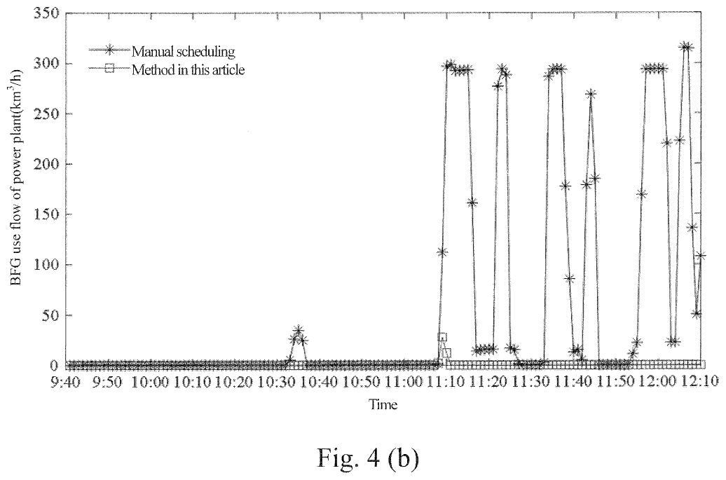

4(a) in FIG. 4 shows a comparison between a scheduling suggestion for BFG use flow of a power plant obtained by using the scheduling model of the present invention and a manual scheduling suggestion. FIG. 4 (b) shows a result comparison between desorption flow obtained by using the scheduling model of the present invention and a manual scheduling suggestion. It can be seen that the desorption flow of the scheduling scheme obtained by using the method of the present invention is low, reducing the waste of gas.

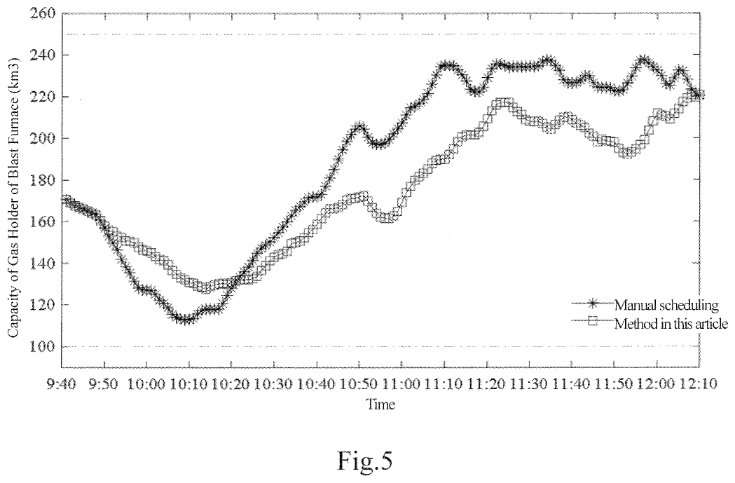

FIG. 5 shows variation trends of the level of the blast furnace gas holders after using the scheduling suggestion of the present invention and the manual scheduling suggestion. It can be seen that by means of the present invention, scheduling knowledge can be fully transferred, to well guide the scheduling decisions, and control the level of the gas holders within safe range.

1. A knowledge transfer-based modeling method for blast furnace gas scheduling systems, comprising the following steps:
Step 1: according to actual pipe network structures of gas scheduling systems, building corresponding ontology models thereof, wherein in the ontology models, let the nodes thereof represent different equipment entities respectively and the connecting lines between nodes represent energy supply and demand balance relations between different equipment entities, including energy generation, use, storage and conversion;
Step 2: conducting feature extraction on the ontology models built in step 1, to find identical structure features of blast furnace gas system and Linz-donawitz gas systems, and determining input and output variables of scheduling models according to the identical structures;
Step 2.1. to determine the similarity between entities of the blast furnace gas systems and Linz-donawitz gas system, building a similarity matrix S first, where each element s(eqₐ, eq_{b}) represents the similarity between nodes of the blast furnace gas system eqₐ and nodes of the Linz-donawitz gas system eq_{b}, as shown in formula (1):
$$s ( {eq}_{a} , {eq}_{b} ) = \{ \begin{matrix}1 & {eq}_{a} = {eq}_{b} \\ \begin{matrix}\frac{η}{\vert I ( {eq}_{a} ) \vert \vert I ( {eq}_{b} ) \vert} \\ {\sum }_{{eq}_{j} ∈ I ( {eq}_{b} )} {\sum }_{{eq}_{i} ∈ I ( {eq}_{a} )} s ( {eq}_{i} , {eq}_{j} )\end{matrix} & \begin{matrix}{eq}_{a} \neq ϵ and \\ ϵ have identical attribute )\end{matrix} \\ 0 & \begin{matrix}{eq}_{a} \neq ϵ and \\ ϵ have different attributes\end{matrix}\end{matrix}$$
where |I(eqₐ)| and |I(eq_{b})| respectively represent the number of nodes indicating the nodes of the blast furnace gas system eqₐ and the nodes of the Linz-donawitz gas system eq_{b} in the ontology models, and η∈[0.6, 0.8] represents a damping coefficient;
Step 2.2. according to the relation between production and consumption of energy media, putting all the generation entities of the blast furnace gas system and the Linz-donawitz gas system into sets R_{LDGin} and R_{BFGin}, and determining the corresponding relation between entities in the two sets;
Step 2.2.1. determining identical entities in the two sets first, each identical entity forming a set of corresponding relation;
Step 2.2.2. for different entities in the sets, according to the size of the similarity s, merging same with the most similar identical entities in respective sets; if there is no identical entity, merging all the entities in R_{LDGin} and R_{BFGin} respectively, and forming a set of corresponding relation;
Step 2.3. conducting the same processing on consumption entities as on the generation entities, obtaining corresponding relations between all the entities of the blast furnace gas system and the Linz-donawitz gas system finally, determining identical structure features thereof, and taking identical structures as input/output variables of the models;
Step 3. extracting energy related data of the blast furnace gas system and the Linz-donawitz gas system from a database, based on the input and output variables of the models determined in step 2, reconstructing membership functions of the scheduling model of the Linz-donawitz gas system, and transforming nodes to be merged;
Step 3.1. using a triangular membership function, wherein the i^{th} membership function of the node is as follows:
$${l}_{i} ( x , {a}_{i} , {b}_{i} , {c}_{i} ) = \{ \begin{matrix}0 & x \leq {a}_{i} \\ \frac{x - {a}_{i}}{{b}_{i} - {a}_{i}} & {a}_{i} \leq x \leq {b}_{i} \\ \frac{{c}_{i} - x}{{c}_{i} - {b}_{i}} & {b}_{i} \leq x \leq {c}_{i} \\ 0 & x \geq {c}_{i}\end{matrix} \qquad ( 2 )$$
where aᵢ, and cᵢ determine “foot”, bᵢ determines “peak”;
Step 3.2. for two interdependent nodes, representing same with p and q respectively, so that the membership functions are lₚᵢ(x, aᵢ, bᵢ, cᵢ) and l_{qi}(x, aⱼ, bⱼ, cⱼ) respectively, where i∈{1, 2, . . . , m}, j∈{1, 2, . . . , n}, m and n respectively represent the number of membership functions of two nodes, and m≥n ; and reconstructing the membership functions of the two nodes by means of formulae (3-5):
$$\begin{matrix}if j = 1 , & \\ \{ \begin{matrix}{b}_{pqj} = {b}_{pj} + {b}_{q 1} \\ {c}_{pqj} = {c}_{pj} + {b}_{q 1}\end{matrix} \\ if j = m & ( 3 ) \\ \{ \begin{matrix}{b}_{pqj} = {b}_{pj} + {b}_{qn} \\ {c}_{pqj} = {c}_{pj} + {b}_{qn}\end{matrix} \\ if 1 < j < m & ( 4 ) \\ \{ \begin{matrix}{b}_{pqj} = {b}_{pj} + \frac{{b}_{qn} - {b}_{q 1}}{2} + {b}_{q 1} \\ {c}_{pqj} = {c}_{pj} + \frac{{b}_{qn} - {b}_{q 1}}{2} + {b}_{q 1}\end{matrix} & ( 5 )\end{matrix}$$
step 3.3. for nodes having relevance, conducting data collection and merge on same first, and then directly determining parameters of membership functions thereof according to artificial experience and data distribution;
Step 4: learning the mapping relation between the blast furnace gas system and the Linz-donawitz gas system according to data distribution features, and transferring membership functions of the Linz-donawitz gas system to the scheduling model of the blast furnace gas system; and mapping the data distribution of the Linz-donawitz gas system to the blast furnace gas system by means of the histogram specification method, to make the two systems have similar distribution features, including the following specific steps:
Step 4.1. for the μ^{th} variable, respectively reading data X_{L}^{μ} of the Linz-donawitz gas system and data X_{B}^{μ} of the blast furnace gas system from the database, and combining same into a new data set D(X_{L}^{μ}, X_{B}^{μ}); discretizing D into p intervals, counting frequency ν under each interval for the data of the Linz-donawitz gas system and the blast furnace gas system respectively, for frequency vectors V_{L}=[ν_{L1}, ν_{L2}, . . . , ν_{Lp}] and V_{B}=[ν_{B1}, ν_{B2}, . . . , ν_{Bp}], where ν_{Lp} represents frequency of the data of the Linz-donawitz gas system under the p^{th} interval, and ν_{Bp} represents frequency of the data of the blast furnace gas system under the p^{th} interval, i.e. the number of data;
Step 4.2. according to the frequency vectors V_{L} and V_{B}, calculating cumulative frequency vectors S_{L}=[s_{L1}, s_{L2}, . . . , s_{Lp}] and S_{B}=[s_{B1}, s_{B2}, . . . , s_{Bp}],
$$\begin{matrix}{s}_{Lp} = {\sum }_{k = 1}^{p} {v}_{Lk} & ( 6 ) \\ {s}_{Bp} = {\sum }_{k = 1}^{p} {v}_{Bk} & ( 7 )\end{matrix}$$
Step 4.3. determining a mapping relation between data intervals of the blast furnace gas system and the Linz-donawitz gas system; first, fixing an interval γ of the data of the blast furnace gas system, and then calculating difference between same and the cumulative frequency of the data of the Linz-donawitz gas system in sequence;
d_{α,β}=|s_{Bα}−s_{Lβ}|, β=1,2, . . . ,p (8)
if the difference d_{α,β}is the minimum, obtaining a new termination serial number λ_{α}=β of the data interval of the Linz-donawitz gas system; so that the data interval α of the blast furnace gas system may correspond to the data interval (λ_{α-1}, λ_{α}] of the Linz-donawitz gas system, where λ₀=0;
Step 4.4. acquiring left border RLₘₗ and right border RLₘᵣ of the data interval (λ_{α-1}, λ_{α}] of the Linz-donawitz gas system and left border RBₘₗ and right border RBₘᵣ of the data interval i of the blast furnace gas system, so that the formula of linear mapping from the data interval of the Linz-donawitz gas system to the data interval of the blast furnace gas system is as follows:
$${f}_{α} ( x ) = \frac{{RB}_{mr} - {RB}_{ml}}{{RL}_{mr} - {RL}_{ml}} x + {RB}_{ml} - \frac{{RB}_{mr} - {RB}_{ml}}{{RL}_{mr} - {RL}_{ml}} {RL}_{ml} \qquad ( 9 )$$
Step 4.5. according to the mapping relation f_{α}(x), transferring a membership function of the Linz-donawitz gas system to the blast furnace gas system, and obtaining a new membership function:
$$\begin{matrix}{l}^{′} ( x , {a}^{′} , {b}^{′} , {c}^{′} ) = \{ \begin{matrix}0 & x \leq {a}^{′} \\ \frac{x - {a}^{′}}{{b}^{′} - {a}^{′}} & {a}^{′} \leq x \leq {b}^{′} \\ \frac{{c}^{′} - x}{{c}^{′} - {b}^{′}} & {b}^{′} \leq x \leq {c}^{′} \\ 0 & x \geq {c}^{′}\end{matrix} & ( 10 ) \\ {a}^{′} = fa ( a ) , {b}^{′} = fb ( b ) , {c}^{′} = fc ( c ) & ( 11 )\end{matrix}$$
where fa( ), fb( ), fc( ) represent the mapping relations corresponding to data intervals in which the data a, b, c of the Linz-donawitz gas system are located;
step 5: based on the input and output variables of the models determined in step 2, reconstructing the rule of the original scheduling model of the Linz-donawitz gas system, and merging the input variables to be merged in the rule antecedent; if the rule to be reconstructed is as shown in formula (12), the variables to be merged are x₁ and x₂, and the reconstructed rule is as shown in formula (13), reconstructing the membership function of the merged variable x′ by means of formulae (3-5), and determining l_{pqk} by means of formula (14);
$$\begin{matrix}if {x}_{1} is {l}_{pi} and {x}_{2} is {l}_{qj} and … , then … & ( 12 ) \\ if {x}^{′} is {l}_{pqnew} and … , then … & ( 13 ) \\ {l}_{pqnew} = \{ {l}_{pqk} \vert {max}_{k} {l}_{pqk} ( {b}_{{x}_{1} , {l}_{pi}} + {b}_{{x}_{2} , {l}_{qj}} ) \} & ( 14 )\end{matrix}$$
after rule reconstruction, if the new scheduling model of the Linz-donawitz gas system has the same structure and data distribution features as the blast furnace gas system, directly transferring the scheduling knowledge to obtain the scheduling model of the blast furnace gas system;
step 6: inputting actual scheduling data of the blast furnace gas system into the scheduling model, and slightly adjusting and optimizing the transferred scheduling knowledge according to the scheduling scheme and deviation rate; since the knowledge obtained by transfer of a Linz-donawitz gas system is incomplete and inaccurate for the blast furnace gas system, further improving the robustness and accuracy of the model using the error threshold;
step 6.1. for the output scheme y, if the deviation between a certain output variable and the actual scheme is greater than the threshold h, indicating that the knowledge obtained by transfer is incomplete and cannot cover all cases of the sample, adding a new scheme for the scheduling model;
step 6.2. if the deviation between each output variable of the output scheme y and the actual scheme is less than the threshold h, optimizing various output membership function parameters by means of particle swarm optimization, where aₒⱼ, bₒⱼ, cₒⱼ represent parameters of all membership functions of the output variable yⱼ, aₒⱼ^{j}, bₒⱼⁱ, cₒⱼⁱ represent parameters of the i^{th} membership function, the actual adjustment scheme of the blast furnace gas system is y′ᵢ, the model output adjustment scheme is yᵢ, if it is defuzzified by means of the centroid method, the optimization goal of particle swarm optimization is to minimize the model output error, as shown in formula (19), and corresponding constraint conditions are as shown in formula (20):
$$\begin{matrix}{min}_{{a}_{oj} , {b}_{oj} , {c}_{oj}} L ( {a}_{oj} , {b}_{oj} , {c}_{oj} ) = \vert {y}_{j} - {y}_{j}^{′} \vert & ( 19 ) \\ s . t . \{ \begin{matrix}{a}_{o}^{i} < {b}_{o}^{i} < {c}_{o}^{i} \\ {a}_{o}^{i - 1} < {a}_{o}^{i} < {c}_{o}^{i - 1} \\ {c}_{o}^{i - 1} < {c}_{o}^{i} \\ 0 \leq {a}_{o}^{i}\end{matrix} . & ( 20 )\end{matrix}$$
